(19) United States
(12) Patent Application Publication
(10) Pub. No.: US 2019/0054680 A1
(43) Pub. Date: Feb. 21, 2019

(54) AN APPARATUS AND METHOD TO MOVE PLASTIC TUBE IN ITS PRODUCTION PROCESS

(71) Applicant: Plastic Pipe Mobile OU, Pärnuy (EE)

(72) Inventor: Seppo TAKALA, Pärnu (EE)

(21) Appl. No.: 16/078,686

(22) PCT Filed: Jan. 26, 2017
(86) PCT No.: PCT/FI2017/050043

§ 371 Date: Aug. 22, 2018

(30) Foreign Application Priority Data
Feb. 23, 2016 (FI) 20160045

(51) Int. Cl. B29C 53/82; B29C 53/58; B29C 53/62

(52) U.S. Cl. CPC B29C 53/821; B29C 53/583; B29L 2023/22; B29C 53/62; B29C 53/581

(57) ABSTRACT

An apparatus to move plastic tube lengthwise in its production process, includes a support organ and move apparatus The counterpart of the support organ rotates with the feeding perimeter speed of the material fed upon it into the same direction with it. The support organ and the move apparatus fit concentrically one after the other. A center axis has bearings to keep it in its place concentrically with the support organ and the move organ. Three essentially lengthwise adapted move organs upon the perimeter the size of the counterpart continuation perimeter or greater perimeter with equal distribution installed move organs are supported with support organs from the center axis and rotate with the center axis. The out part of the mover of every move organ press against the inner surface of the plastic tube to move itself and the plastic tube into its production direction with the speed.

### FIELD

The aspects of the disclosed embodiments areare directed to an apparatus and method to move plastic tube lengthwise in its production process, the mentioned apparatus consisting of a support organ (1) that is a drum or a race and of a drawing-out device.

The usages of the invention are large tubes production processes. The large plastic tubes, the inside diameter of which can vary between 1000-6000 mm and can be even larger are produced to be used for instance as wastewater drains, bridge tubes, water-supply pipes, etc.

### BACKGROUND

The continuous production of this kind of tubes is performed nowadays following a known method so that material is fed upon a rotating and quite short core or race with the inside diameter of the tube and this forms the wall of the tube in the production. This material can be plastic ribbon or a closed profile, like for instance a rectangular profile and it is fed with the speed corresponding to the rise of the width of this material. A screw shape joint is formed in the joint locations of the neighboring material rounds. The material in fed either from a reel or directly from an extruder and it is directed upon the core or the race in the angle with the core middle axis normal that corresponds to the rise. As the plastic tube in the production rotates, according the technology of today it is moved in the direction of the axis away from the core or race as much as the mentioned rise per round demands with a steady speed and thus the plastic ribbon feeders can be kept stationary. At the same time, melted plastic material is fed from another feeder to the joint of the tube to weld it. In addition to this, it is possible to add layers to the plastic tube in the same process if it is needed. As an example, a stiffener layer upon the ribbon layer and the surface layer upon that layer can be made so that the layer upon the core or race is an inside layer. The apparatus and the method according to the invention are very suitable for moving this kind and different kinds of tubes.

When the plastic tube is produced from a before mentioned enclosed profile, it is known to fill also this capsule with for instance plastic foam. As an example of this a construction can be mentioned where the capsule walls are made of PP or HDPE and the material inside the mentioned capsule is the same plastic material foam. The joining of this kind of material happens usually by welding the surface layers of the profiles in the screw shape joint. The apparatus and the method according to the invention are also very suitable to move this kind of tubes.

When a large tube is moved according to the known technology, in one solution the rolls of the mentioned race are used so that they are adjusted skew in relation to the lengthwise direction of the plastic tube. The skew of the rolls is usually <5° and their direction is adopted to push the tube under production into its direction of the completion. This solution has been presented in the patent publication WO 2012 090185.

Another moving method for a tube and apparatus has been presented in the patent publication FI 2012 0234. In this solution the tube is rotated using a chain or a belt that is tightened around the tube and at the same time the rise of the joint of the tube moves the tube to the direction of the production of the tube.

The disadvantage of both of the before mentioned techniques can be seen that between the moving organ (rolls of race, chain/belt) and the tube in contact with them, sliding takes place. The moving of the plastic tube under production demands that the moving organ is able to move the tube with exactly the same speed as the production speed of the tube is. The before mentioned sliding causes disturbance in the production of the tube: The tube does not move sufficiently within a certain time and thus the moved distance is different from the rise. When the tube is moved using the rolls the sliding takes place between the inside surface of the tube and the rotating rolls and when the chains or belts move the tube the sliding point is between the outside surface of the tube and the chain/belt.

### SUMMARY

The aspects the disclosed embodiments are directed to achieve such an apparatus and method that avoid the disadvantages of the known technology. It is characteristic for the solution according to the invention what has been presented in the characterizing part of the independent claim 1.

The greatest advantage of the aspects of the disclosed embodiments in relation to the known technique can be seen that there is no sliding between the move organ and the tube that is in contact with it. This leads to the situation that the process is stabile without disturbance and the plastic tube is of high quality.

The mentioned core is called in the field of inventions “a starting core” and “a drum”.

In this document, the raw material of the plastic tube that is a ribbon and also the different closed profiles are called “materials”

### BRIEF DESCRIPTION OF THE DRAWINGS

The aspects of the disclosed embodiments are described in more detail in the enclosed drawings, where

FIG. 1, presents the apparatus according to the present disclosure seen directly from the side,

FIG. 2, presents the before mentioned apparatus directly from the end,

FIG. 3, presents the before mentioned apparatus in 3D,

FIG. 4, presents FIG. 3 spot A zoomed,

FIG. 5, presents the tube production process seen from the FIG. 1 direction,

FIG. 6, presents the before mentioned process from the direction of the FIG. 2,

FIG. 7, presents the before mentioned process from the direction of the FIG. 3,

FIG. 8, presents FIG. 5 cut B-B,

FIG. 9, presents the setting when the system is being started,

FIG. 10, presents another application of the support organ.

### DESCRIPTION OF THE DISCLOSED EMBODIMENTS

In the following part, one advantageous solution of the system and its operation is described referring to the figures.

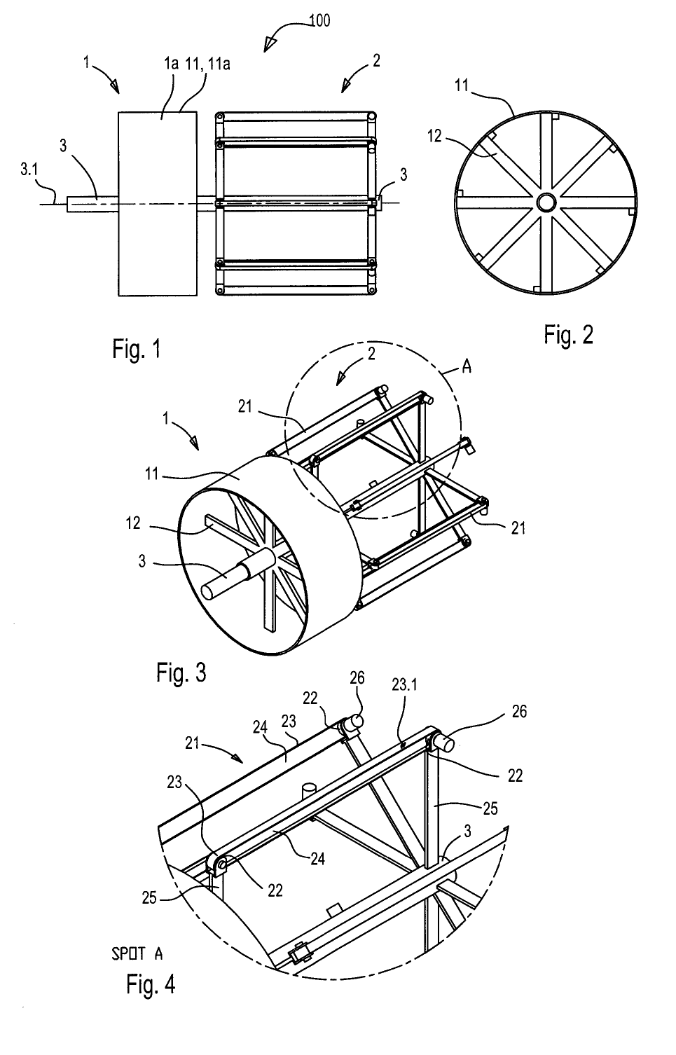

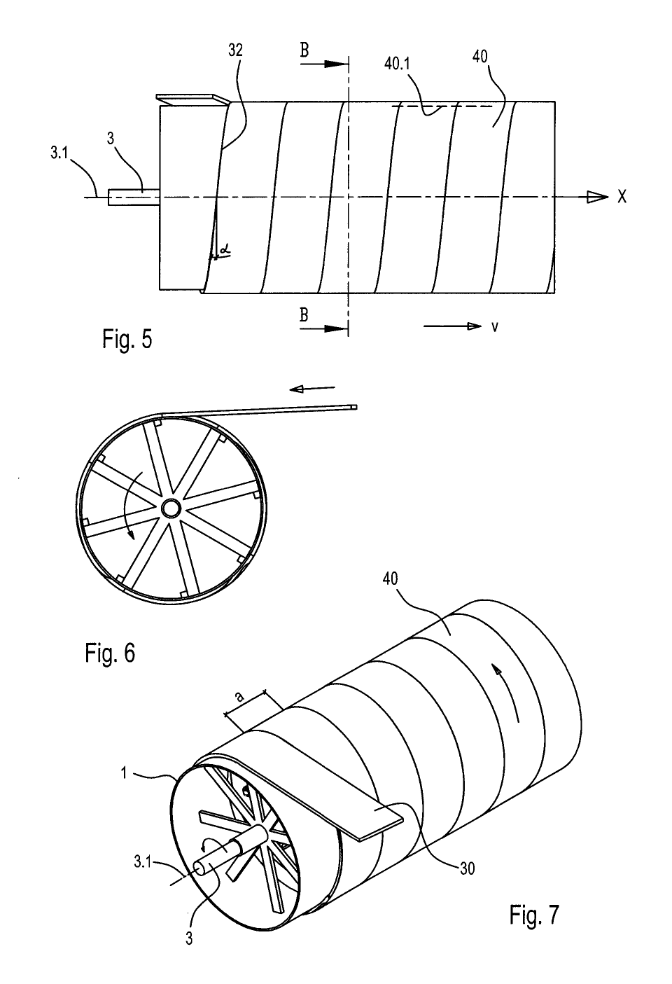

In FIGS. 1-3 there has been shown an apparatus 100 according to the present disclosure. The drawing from the side (FIG. 1) presents its main parts; support apparatus 1 that is a drum in this example, move apparatus 2 and the center axis 3. The center axis has bearings to keep it to its place and it is adapted to rotate horizontally around itself 3.1. The drum 1a is around the center axis 3 concentrically and its cylinder shape counterpart 11 that in this example is a shell 11a has been supported to the center axis using a support organ 12. The drum has been adjusted to rotate along the center axis 3. The move apparatus 2 has been fit to the side of the support apparatus 1 and its outer perimeter is concentric with the drum. The out part of the move organ is formed by the perimeter adapted move organs 21, whereof each consists of at least two wheels 22 and movers 23 that resemble drive belts and are installed around these wheels to rotate the same perimeter speed and between the wheels 22 installed support 24 that supports at least the outer part 23.1 of the support organ essentially to the direction of the center axis 3. Every move organ 21 has been supported by two support organs 25 to the center axis 3 in such a way that they rotate alongside with the center axis and maintain their positions in the perimeter of the move apparatus 2 both in the direction of the axis and the radius. In this example, there are eight move organs 21 and in the center axis of the wheel 22 at that end of the move organ that is farther from the support apparatus 1 a rotator 26 has been installed to rotate this wheel so that the outer part 23.1 of the move organ is able to move in a continuous movement directly from the drum 1 outwards. The out surfaces of the outer parts 23.1 of the move organs have been set essentially on the continuation of the shell 11 of the out perimeter of the drum.

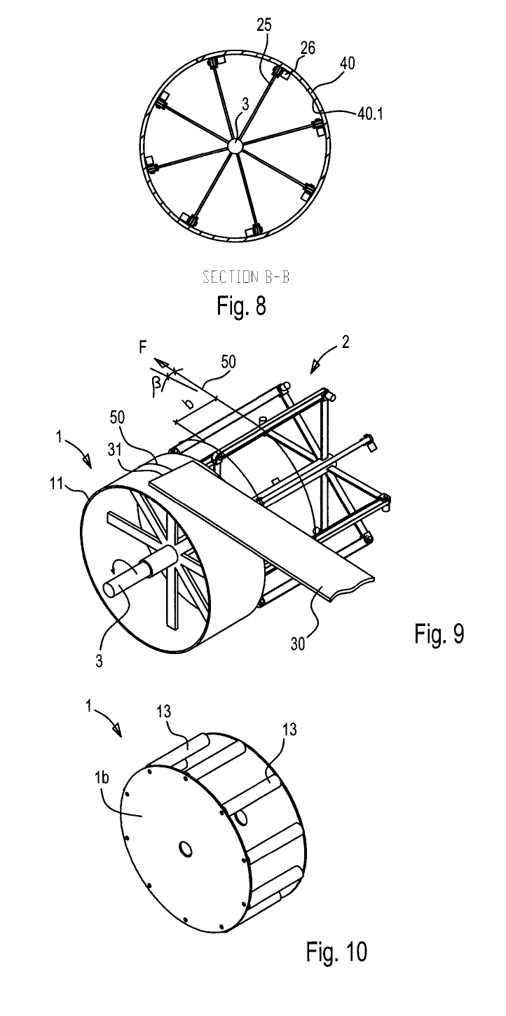

The method according to the present disclosure is performed using the before described apparatus 100 according to the FIGS. 5-9 in such a way that a rope, a ribbon or other drawing appliance 50 (FIG. 9) is fastened to the end 31 of the material 30 to be fed, which material in this example is plastic ribbon and this drawing appliance is rotated upon the support apparatus 1 some rounds before starting to produce the plastic tube so that it advances at least about the distance of the rise a (FIG. 7) of the tube under production with same rise b. When the production of the tube is started the center axis 3 is set to rotate with motor power around its axis 3.1 into the direction pointed out in the FIG. 7 and then the support apparatus 1 and the move apparatus 2 start rotating with it with the same speed into the same direction. At the same time, the draw organ 50 is drawn so that it tightens against the counterpart 11 of the drum that is against the out perimeter of the shell. When the material 30 that is plastic ribbon bends against the shell and starts getting around it the drawing appliance gets off the shell tangentially. When the feeding angle of the plastic ribbon upon the drum is the same as the rise angle α and the exhaust angle β of the draw appliance are same, the plastic ribbon that has been fed upon the drum slides upon the smooth shell of the drum into the production direction X because of the effect of the component of the center axis 3 drawing power F. Thus the draw organ 50 and its continuation end 31 move from the shell on the move organs 21 of the move apparatus and their common perimeter. The move organs have been started at the same time with the center axis 3 and their every rotator 26 has been adapted to their own move organ movements so that their out part 23.1 moves into the production direction X of the plastic tube away from the drum 1. The speed of the movers 23 is the production speed v of the plastic tube, that is the rise a divided by rotation speed of the drum and the move apparatus. When the end 40 of the plastic tube in the production appears upon the move organs 21 the out parts 23.1 of the movers 23 get pressed against the inside surface 40.1 of the plastic tube and move the tube into its production direction X with its production speed v. When the plastic ribbon winds upon the drum more than one round the spiral shape joint 32 welding between the ribbon rounds is started using melted plastic from a nozzle. Evidently, the plastic tube 40 coming to the move apparatus 2 is of its construction sufficiently stiff and solid that it is possible to get sufficient pressure between the inside surface 40.1 and the move apparatus that there will not be sliding between the mentioned parts.

The rotation speeds of the tube 40 under production and move apparatus 2 can be calibrated to be the same or different so that the drawer has a greater speed than the speed of the support apparatus 1 and the rotation speed of the plastic tube 40. This difference in the rotation speeds is then relatively small and it can be used for instance to get extra tightening when compensating the heat expansion of the tube/apparatus. The mentioned difference in the rotation speeds can be arranged for example by installing a gear to the center axis 3 and then the support apparatus 1 and the move apparatus 2 have different rotation speeds.

Another way to compensate the mentioned heat expansions is to set the out perimeter of the move apparatus 2 larger than the out perimeter of the counterpart 11 in which case the perimeter speeds are different.

The before described tightening can also be realized by setting the move organs 21 and their movers lengthwise to a certain small angle in relation to the center axis 3.

The tightening in the before mentioned ways of the plastic tube 40 under production is in all cased performed within such limits that the welds of the tube can stand the strain.

In the method according to the present disclosure, the possibly realized perimeter speed difference of the out surface of the counterpart 11 and the out surface of the movers 23 is always so that the latter speed is greater.

The move organs 21 of the move apparatus can be adjusted before beginning the process into such a state that there is a sufficient tightness between them and the plastic tube 40 and that there is no sliding. The move organs can also be made to be adjusted in such a way that the sufficient tightness between the movers 23 and the inside surface 40.1 of the plastic tube is obtained by adjusting their position after starting the production process.

A sufficient number of the move organs 21 can always be fit to the perimeter so that supporting the plastic tube into an essentially round shape is obtained. Their number can be depending on the layer thickness of the plastic tube 3-10 or even more.

The length of the tube 40 to be produced is not bound to for instance the size of the production building because it can also be done outdoors. The lightness, simplicity and small energy need make it possible to be transported and installed to the usage site of the plastic tubes. The process is continuous and material 30 and melted plastic feeding equipment stay essentially in their place and thus it is not necessary to limit the length of the tube to any equipment dimensions.

The diameter of the plastic tube can be for example 1000-6000 mm and even larger and smaller tubes can be produced with the method and the apparatus according to the present disclosure.

Also the plastic tube 40 wall thicknesses in the method and apparatus in accordance with the present disclosure can be chosen freely.

It is also possible to add layers to the plastic tube 40 when producing using the apparatus and the method according to the present disclosure. In this case, the inside tube is moved in the before described way and for instance a stiffening layer and a surface layer are fed upon it. In this case, it must be controlled that the contact between the move organ and the inside tube inside surface is sufficiently good to move the whole construction without disturbance.

The rotation power of the wheels 22 of the move organs 21 can be made either by individual rotation apparatus 26, like for instance axis motor, electric motor, fluid motor, or can be transferred to the wheels mechanically from one or more rotators through the center axis 3. The center axis 3 can also operate as the rotator the rotation power of which is used to get the wheels 22 to rotate. There can also be more than two wheels in the move organ 21 and the rotation power can be transferred to more than one wheel of the move organ.

The speed of the wheels 22 and thus movers 23 can be adjusted according to the case what the rise a and the material 30 feeding speed is.

The mover 23 of the move organ can be a belt, a chain, a rope, or a corresponding organ rotating around the wheels 22. The move organ 21 of the move apparatus 2 can also be composed so that two or more movers 23 are put in a row so that their out parts 23.1 form together contacts with the inside surface 40.1 of the tube.

The support 24 of the movers has been fit between the wheels 22. If there are more than two wheels the support 24 can be fit between all the neighboring wheels if necessary. A tightener can be fastened to the support 24 in order to get a suitable friction between thee mover and the wheel. On the other hand, the shape of the inside surface of the mover can prevent the sliding between the wheel and the mover.

The support apparatus 1 can be a race 1b (FIG. 10) instead of a drum 1a in which case the counterpart 11 is composed of those parts of the perimeters of the wheels 13 against which the material 30 to be fed and the inside surface 40.1 in each case lean. A sufficient amount off rolls is installed to the race 1b so that the tube coming upon them gets a sufficiently round shape. It is not necessary to fasten the race 1b to the center axis when the rolls are set to rotate around their axles. If the rolls are not set to rotate, the race is fastened to the center axis 3.

It should be noticed that even though this description concentrates on one type for the present disclosure advantageous implementation example this does not, however, want to limit the usage of the present disclosure only to this kind of example, instead, many variations are possible within the inventive idea stated in the claims.

1. An apparatus to move lengthwise plastic tube with spiral joint in its production process, which apparatus is composed of a support apparatus and a move apparatus and where the counterpart of the support apparatus has been set to rotate with the same perimeter speed as the material to be fed upon it in the same direction with it and which apparatus also has the center axis that has been supported to its place with bearings concentrically with the support apparatus and the move apparatus,
wherein
a. the support apparatus and the move apparatus that include lengthwise move organs to move the plastic tube have been set concentrically one after the another so that the support organ is located before the move organ when advancing to the direction of the process,
b. the support apparatus, the counterpart and the move apparatus have all been put inside the material/tube,
c. the move apparatus includes the move organs that have been set essentially on the counterpart continuation size or greater perimeter diameter at least essentially with almost equal intervals lengthwise spaced that have been supported to their places with supports from the center axis and set to rotate alongside with the center axis and which are sufficient in number to support the plastic tube essentially to a round shape,
d. the out part of the mover of every move organ has been set to press against the inside surface of the plastic tube and move itself with machine power and thus move the plastic tube 40 into its production direction with the production speed.

2. The apparatus according to the claim 1 wherein the perimeter speed of the movers of the move apparatus can be calibrated with the perimeter speed of the counterpart to be equal or greater.

3. The apparatus according to the claim 1 wherein the movers of the move apparatus have been set lengthwise divergent with the center axis in such a way that the mentioned movers are essentially parallel.

4. The apparatus according to the claim 2 wherein the diameter of the out perimeter of the movers of the move apparatus has been set greater than the counterpart out diameter.

5. The apparatus according to the claim 2 wherein the rotation speed of the move apparatus can be set greater than the support apparatus rotation speed.

6. The apparatus according to claim 1 wherein the support apparatus is a drum or a race.

7. The apparatus according to claim 1 wherein the mover of the move organ has been set to rotate around at least two wheels and thus the mover is a loop-like organ and at least one of the mentioned wheels has been set to rotate to move the mover.

8. The apparatus according to claim 1 wherein the move organ has been made by putting at least two movers in a row.

9. The apparatus according to the claim 1 wherein the pressing power of the movers against the inside surface of the plastic tube can be controlled during the production process.

10. The apparatus according to the claim 9 wherein the move organ consists of a tightener to tighten the mover against the inside surface of the plastic tube.

11. The apparatus according to claim 7 wherein the rotation apparatus of the wheel is an electric motor, a pole motor or fluid motor or it is set to get its rotation power from the center axis rotation.

12. The method to move a spiral joint tube lengthwise in its production process wherein the apparatus according to claim 1 is used.

13. The method according to the claim 12 wherein using the method plastic tube with the inside diameter of 1000-6000 mm is produced.

14. The method according to the claim 13 wherein using it plastic tube is produced having as its material plastic ribbon or a certain closed case like profile, like a rectangle.
